(19) United States
(12) Patent Application Publication
(10) Pub. No.: US 2005/0151301 A1
(43) Pub. Date: Jul. 14, 2005

(54) Heating and setting machine and method

(75) Inventor: Martin Bentham, Ardsley Barnsley (GB)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Sara Lee Corporation

(21) Appl. No.: 11/019,405

(22) Filed: Dec. 22, 2004

Related U.S. Application Data
(63) Continuation-in-part of application No. 10/330,922, filed on Dec. 27, 2002, now Pat. No. 6,835,258.

(51) Int. Cl. B29C 71/00

(52) U.S. Cl. 264/345; 425/446

(57) ABSTRACT

A machine and method for heating and setting a garment to a desired shape. The machine includes heating chambers, heating device, and a conveying device. The heating chambers are selectively isolateable from one another. The heating device provides dry heat or moist heat to each of the heating chambers. The conveying device moves a plurality of carriers through each of the heating chambers. The carriers have the desired shape and receive the garment thereon. The method includes loading the garment on a carrier having the desired shape, moving the carrier through a plurality of heating chambers; exposing the carrier to dry heat or moist heat in each of the plurality of heating chambers; and selectively isolating the plurality of heating chambers from one another so that the garment absorbs a desired heat profile during movement through the plurality of heating chambers.

### CROSS REFERENCE TO RELATED APPLICATIONS

This application is a continuation-in-part of application Ser. No. 10/330,922 filed Dec. 27, 2002, now U.S. Pat. No. 6,835,258.

### BACKGROUND OF THE INVENTION

1. Field of the Invention

The present invention relates to machines and methods for textile and garment manufacturing. More particularly, the present invention relates to machines and methods for heating and setting the shape of textiles, garments, and fabric tubes.

2. Description of Related Art

In the conventional garment manufacturing processes, a number of distinct finishing steps are performed to a garment blank to define the finished garment. One common finishing step is heating a garment, imparting a desired shape or configuration (hereinafter “shape”), and then setting the garment in that desired shape.

Many prior art machines produce a lower number of garments than desired. Other more complex machines can produce an acceptable number of garments, but can do so only because they are limited to one heat setting cycle corresponding to that garment.

It has been determined that there is a continuing need in the garment manufacturing industry for heating and setting machines that overcome and/or mitigate one or more of the aforementioned deleterious effects and deficiencies of the prior art.

### BRIEF SUMMARY OF THE INVENTION

It is an object of the present invention to provide a heat and setting machine and method for textiles, garments, and fabric tubes.

It is another object to provide an adaptable heat and setting machine and method.

It is yet another object to provide a heat setting machine and method that increases the speed and flexibility of the production of textiles, garments, and fabric tubes (hereinafter “garment”) requiring shaping.

These and other objects and advantages are provided by a machine having heating chambers, a heating device, and a conveying device. The heating chambers are selectively isolateable from one another. The heating device provides dry heat or moist heat to each of the heating chambers. The conveying device moves a plurality of carriers through each of the heating chambers. The carriers have a desired shape and receive a garment thereon.

These and other objects and advantages are provided by a method of heating and setting a garment to a desired shape. The method includes loading the garment on a carrier having the desired shape, moving the carrier through a plurality of heating chambers; exposing the carrier to dry heat or moist heat in each of the plurality of heating chambers; and selectively isolating the plurality of heating chambers from one another so that the garment absorbs a desired heat profile during movement through the plurality of heating chambers.

The above-described and other features and advantages of the present invention will be appreciated and understood by those skilled in the art from the following detailed description, drawing, and appended claims.

### BRIEF DESCRIPTION OF THE DRAWING

FIG. 1 is a perspective view of an exemplary embodiment of a heat setting machine according to the present invention.

### DETAILED DESCRIPTION OF THE INVENTION

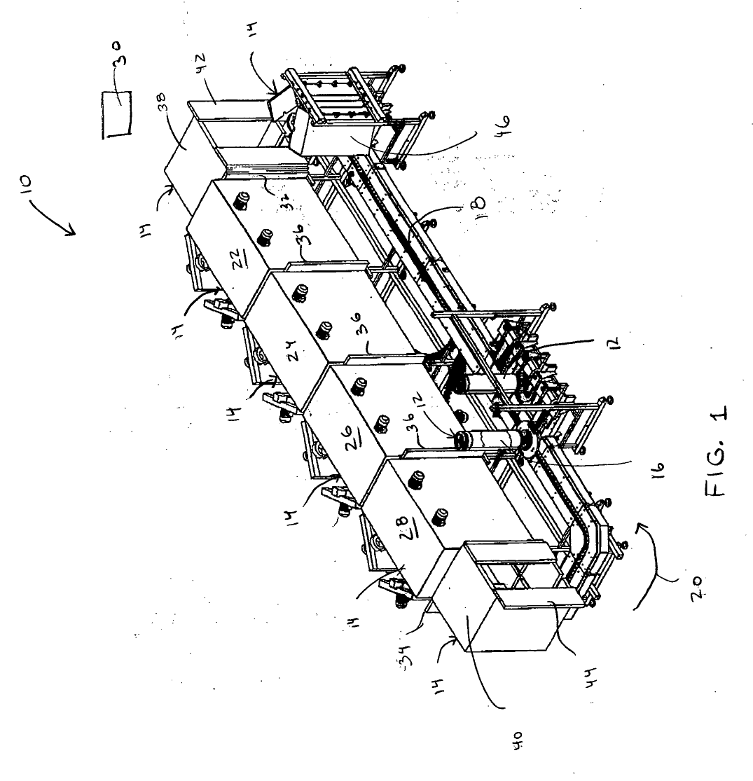

Referring to the drawing and in particular to FIG. 1, an exemplary embodiment of a garment heating and setting machine according to the present invention is generally referred to by reference numeral 10. Machine 10 can selectively move one or more garment carriers 12 through one or more finishing stations 14. Advantageously, machine 10 is a modular machine that provides for a high production rate of garments and is easily adaptable for a variety of different garments and fabrics.

Finishing stations 14 expose carrier 12 to conditions sufficient to heat set a garment 16 disposed on the carrier. In this manner, machine 10 can set the shape of garment 16, which has thermoplastic synthetic fibers, to the shape of carrier 12.

Carrier 12 has a predetermined shape that substantially matches the shape of one or more portions of the desired finished garment. For example, carrier 12 can, when used in the production of women's shirts and/or brassieres, have a three-dimensional shape replicating the upper torso of a woman including predetermined chest and breast sizes. An exemplary carrier 12 contemplated for use with the present disclosure is shown and described in commonly owned and assigned U.S. Patent Publication No. 2004/0222249, the contents of which are incorporated by reference herein.

For purposes of clarity, machine 10 is shown having two identically shaped carriers 12. Of course, it is contemplated for machine 10 to include more or less than two carriers 12 and/or for the carriers to have the same or different shapes.

Machine 10 includes a conveying device 18 such as, but not limited, to a chain, a belt, and other conveying devices. Conveying device 18 is driven by a motor (not shown) in a machine direction 20 through and/or past finishing stations 14.

Machine 10 can selectively engage and disengage carrier 12 from conveying device 18. In this manner, machine 10 can be supplied with carriers 12 having any desired shape. Thus, machine 10 can be easily converted from producing garments having one shape to garments having a different shape. In some embodiments, machine 10 can simultaneously produce garments having a different shape.

Finishing stations 14 include a first heating chamber 22, a second heating chamber 24, a third heating chamber 26, and a fourth heating chamber 28. Machine 10 defines machine direction 20 of conveying device 18 through each of the heating chambers 22, 24, 26, 28. Thus, carrier 12 can be moved through the heating chambers 22, 24, 26, 28 to expose garment 16 to a desired heat profile. While in heating chambers 22, 24, 26, 28, machine 10 exposes garment 16 to heat sufficient in time and temperature to conform at least some of the fibers of garment 16 to the shape of carrier 12.

Heating chambers 22, 24, 26, 28 include a heating device 30 for heating each chamber to a desired temperature. In this manner, the heating chambers 22, 24, 26, 28 can be controlled to the same and/or different temperatures.

Heating device 30 can provide dry hot air and/or atmospheric steam to heating chambers 22, 24, 26, 28. Preferably, heating device 30 can heat chambers 22, 24, 26, 28 up to about 220 degrees Celsius, with between about 160 to about 200 degrees Celsius being most preferred. In the illustrated embodiment, heating chambers 22, 24, 26, 28 share a common heating device 30. However, it is contemplated by the present disclosure for each heating chamber 22, 24, 26, 28 to have a separate heating device 30. For example, each heating chamber 22, 24, 26, 28 can have its own separate furnace and/or electric heating device for providing hot air and/or atmospheric steam to its respective chamber. In this manner, at least some of the heating chambers 22, 24, 26, 28 can be provided with dry heat (i.e., hot air) while other heating chambers are provided with moist heat (i.e., atmospheric steam).

Preferably, machine 10 includes an entrance door 32 positioned at the entrance of first heating chamber 22 and an exit door 34 positioned at the exit of fourth heating chamber 28. In addition, machine 10 includes isolation doors 36 positioned between adjoining heating chambers 22, 24, 26, 28. Machine 10 can use isolation doors 36 (all shown in the open position) to selectively isolate chambers 22, 24, 26, 28 from one another. In this manner, machine 10 can allow adjoining chambers to be maintained at different temperatures and/or for atmospheric steam to be injected into the chambers, as desired.

In this manner, machine 10 can provide as many as four different temperature zones when all isolation doors 36 are closed or as few as one temperature zone when the isolation doors are open. Accordingly, machine 10 is a modular machine that can easily be adapted to heat garments 16 that only require one heating temperature in all four chambers. Alternately, machine 10 can easily be adapted to heat garments 16 that only require multiple heating temperature by closing the chambers from one another.

In use, machine 10 opens entrance door 32 to allow conveying device 18 to move carrier 12 into first heating chamber 22. Once carrier 12 is in first heating chamber 22, machine 10 closes the entrance door 32. Machine 10 can control conveying device 18 to move carrier 12 through one or more of heating chambers 22, 24, 26, 28. Once the heating cycle is completed, machine 10 opens exit door 34 to allow conveying device 18 to move carrier 12 out of fourth heating chamber 28. After carrier 12 out of fourth heating chamber 28, machine 10 closes exit door 34.

Machine 10 can be configured to expose garment 16 to any desired heat profile necessary to set the shape of at least some of fibres in the garment. The desired heat profile of machine 10 will depend on the yarn type, fabric blend, and knit construction of garment 16. For example, where garment 16 is made of nylon 66, machine 10 can expose the garment to a temperature of about 180 to about 190 degrees Celsius for about 30 to 60 seconds. In another example where garment 16 is made of nylon 6, machine 10 can expose the garment to a temperature of about 165 to about 180 degrees Celsius for about 30 to 60 seconds. In yet another example where garment 16 is made of polyester, machine 10 can expose the garment to a temperature of about 190 to about 200 degrees Celsius for about 30 to 60 seconds.

As seen in the embodiment illustrated in FIG. 1, finishing stations 14 can include an entry chamber 38 before first heating chamber 22. Machine 10 defines machine direction 20 of conveying device 18 through entry chamber 38. Entry chamber 38 includes an entrance door 42 (shown in the open position) that is selectively openable and closeable. In the open position, door 42 allows carrier 12 to be moved into entry chamber 38.

As seen in the embodiment illustrated in FIG. 1, finishing stations 14 can include an exit chamber 40 after fourth heating chamber 28. Machine 10 defines machine direction 20 of conveying device 18 through exit chamber 40. Exit chamber 40 includes a selectively openable door 44. In the open position, door 44 allows carrier 12 to be moved out of exit chamber 40. Preferably, exit chamber 40 includes a cooling device (not shown) for removing heat from and, thus, reducing the temperature of garment 16 to set the fibers of the garment to the shape of carrier 12.

As also seen in the embodiment illustrated in FIG. 1, finishing stations 14 can include a wetting chamber 46 before entry chamber 38. Machine 10 defines machine direction 20 of conveying device 18 past wetting chamber 46 so that carrier 12 can be taken offline of the conveying device during wetting. Wetting chamber 46 includes selectively openable doors 48. In the open position, doors 48 allow carrier 12 to be moved into and out of wetting chamber 46. Wetting chamber 46 can apply a wetting agent to garment 16 prior to exposure to the heat of heating chambers 22, 24, 26, 28. The wetting agent applied by wetting chamber 46 can include agents such as, but not limited to water, moist steam, scouring agent, bleaching agent, or combinations thereof for cleaning, treating, and/or relaxing garment 16.

In a preferred embodiment, machine 10 can include one or more loading stations 46. Machine 10 defines machine direction 20 of conveying device 18 past loading stations 46 so that carrier 12 can be taken offline of the conveying device during loading/unloading. Stations 46 can be used to load garment 16 onto carrier 12 and/or to unload heat set garments from the carrier. In addition, stations 46 can be used to load carriers 12 onto conveying device 18 and/or or unload the carriers from the conveying device.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

1. A machine for heating and setting a garment to a desired shape, comprising:
a plurality of heating chambers being selectively isolateable from one another;
a heating device for providing dry heat or moist heat to each of said plurality of heating chambers; and
a conveying device for moving a plurality of carriers through each of said plurality of heating chambers, said plurality of carriers having the desired shape and being configured to receive the garment thereon.

2. The machine as in claim 1, wherein said heating device comprises a separate heating device for each of said plurality of heating chambers.

3. The machine as in claim 1, wherein said heating device heats said plurality of heating chambers up to about 220 degrees Celsius.

4. The machine as in claim 1, wherein said heating device heats said plurality of heating chambers to between about 160 to about 220 degrees Celsius.

5. The machine as in claim 1, further comprising a plurality of isolation doors for selectively isolating said plurality of heating chambers from one another.

6. The machine as in claim 5, wherein said plurality of isolation doors and said heating device cooperate to maintain said plurality of heating chambers at the same and/or different temperatures.

7. The machine as in claim 1, further comprising an exit chamber, said conveying device moving said plurality of carriers through said exit chamber after said plurality of heating chambers, said exit chamber having a cooling device for removing heat from said plurality of carriers.

8. The machine as in claim 1, further comprising a wetting chamber, said conveying device moving said plurality of carriers past said wetting chamber before said plurality of heating chambers, said wetting chamber applying a wetting agent to said plurality of carriers.

9. The machine as in claim 1, further comprising at least one station for loading and/or unloading the garment from said plurality of carriers.

10. A method of heating and setting a garment to a desired shape, comprising:
loading the garment on a carrier having the desired shape;
moving said carrier through a plurality of heating chambers;
exposing said carrier to dry heat or moist heat in each of said plurality of heating chambers; and
selectively isolating said plurality of heating chambers from one another so that the garment absorbs a desired heat profile during movement through said plurality of heating chambers.

11. The method as in claim 10, wherein exposing said carrier to dry heat or moist heat comprises heating said plurality of heating chambers up to about 220 degrees Celsius.

12. The method as in claim 10, wherein exposing said carrier to dry heat or moist heat comprises heating said plurality of heating chambers from between about 160 to about 200 degrees Celsius.

13. The method as in claim 12, further comprising maintaining said plurality of heating chambers at the same and/or different temperatures.

14. The method as in claim 10, further comprising moving said carrier through an exit chamber to remove heat from the garment after said carrier absorbs said desired heat profile.

15. The method as in claim 10, further comprising moving said carrier through a wetting chamber to apply a wetting agent to the garment before the garment absorbs said desired heat profile.
